(19) United States
(12) Patent Application Publication
(10) Pub. No.: US 2006/0189795 A1
(43) Pub. Date: Aug. 24, 2006

(54) Use of ph-responsive polymers

(76) Inventors: James Van Alstine, Uppsala (SE); Camilla Larsson, Uppsala (SE); Ronnie Palmgren, Uppsala (SE); Asa Rudstedt, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(21) Appl. No.: 10/547,568

(22) PCT Filed: Mar. 18, 2004
(86) PCT No.: PCT/SE04/00411

§ 371 Date: Aug. 29, 2005

(30) Foreign Application Priority Data
Mar. 20, 2003 (SE) 0300791-1

(51) Int. Cl. C07K 14/47; B01J 20/22

(52) U.S. Cl. 530/412; 502/401

(57) ABSTRACT

The present invention relates to a method of isolating target compounds from a liquid, which comprises at a first pH, contacting the liquid with a separation medium that exhibits surface-localised pH-responsive polymers in to adsorb the target compound via hydrophobic interactions; and adding an eluent, which is of a second pH and provides a conformational change of said pH-responsive polymers to release said compounds. The elution is advantageously performed by a pH gradient and/or by a salt gradient.

### TECHNICAL FIELD

The present method relates to a method of isolating at least one target compound from a liquid, wherein the isolation is performed by adsorbing said target compound to a separation medium and subsequently to elute the target compound from the medium. The medium used in the method according to the invention comprises pH-responsive polymers localised to its surface. The invention also encompasses the use of pH-responsive polymers in the preparation of a separation medium. BACKGROUND

Target compounds are isolated from other components in a solution in many applications, such as in purification of liquids from contaminating species, and isolation of a desired compound such as a protein or another biomolecule from a solution. With the recent growth of biotechnology and increased use of recombinantly produced products, comes enhanced need for efficient purification schemes. In many cases, high demands of purity of the compound produced are required to ensure safety in use, whether the compound produced is a biomolecule or some other organic or even inorganic compound.

Due to its versatility and sensitivity, chromatography is often the preferred purification method for biomolecules and medical products. The term chromatography embraces a family of closely related separation methods, which are all based on the principle that two mutually immiscible phases are brought into contact. More specifically, the target compound is introduced into a mobile phase, which is contacted with a stationary phase, which is typically a solid matrix. The target compound will then undergo a series of interactions between the stationary and mobile phases as it is being carried through the system by the mobile phase. The interactions exploit differences in the physical or chemical properties of the components in the sample. The interactions can be based of one or more different principles, such as charge, hydrophobicity, affinity etc. Hydrophobic and related interactions are utilised in various applications for separation of target compounds from liquids, such as filtration and chromatography. In hydrophobic interaction chromatography (HIC) the mobile phase is typically aqueous and the matrix consists of hydrophobic groups coupled to a hydrophilic matrix, whereas in reverse phase chromatography (RPC), an organic mobile phase and less polar, i.e. more hydrophilic, matrices are typically used Interactions between the media and solutes surfaces are often promoted via addition of salts or other lyotropic agents. Thus, HIC typically involves less hydrophobic and more aqueous environments than RPC and, in many applications, HIC is more suitable to larger MW proteins and other fragile substances. However, in some applications there is no clear line between RPC and HIC matrices but in mobile phase choices. Thus, in such cases, media used for HIC can also work for RPC and vice versa.

HIC interactions between the target molecules and the stationary phase are primarily controlled by mobile phase ability to hydrate the target molecule, as influenced by salts and other additives, coupled to hydrophobic interactions stabilising interaction between targets and medium. Other interactions, e, g. van der Waals, charge-charge, etc. may play secondary but significant roles in regard to protein retention, structural stabilisation and resolution with different target molecules. Typically adsorption of target molecules to a HIC medium is conducted at higher mobile phase salt concentrations, while elution occurs at lower salt concentrations. Salt gradients are often used to enhance selectivity amongst several solutes. When such a gradient is run the most hydrophobic compounds will ideally be eluted last. In the case of proteins, the relationship between protein hydrophobicity and HIC elution is not completely understood. Highly charged and soluble proteins, which possess hydrophobic surface regions, may elute late in HIC.

In protein purification, HIC has become of growing interest as it is complementary to other chromatographic methods, such as gel filtration, affinity chromatography and ion exchange chromatography. More specifically, HIC has been successfully used at both the initial stages of downstream processing, e. g. after salt precipitation and before ion exchange, and at later stages, e. g. to remove target proteins that have been denatured during previous processing steps. However, it may still involve drawbacks under certain circumstances.

One of the most significant drawbacks to HIC, which also applies to RPC, is that some target proteins may become denatured during the process. For example, the high salt concentration buffers required for HIC may be harmful for sensitive target compounds, such as proteins, in which case denaturation may be promoted. Chaotropic or protein stabilising additives can be used to alleviate this drawback, which however will require an additional downstream step for their removal, consequently increasing the total cost of the process. Protein denaturation can also be caused by hydrophobic interaction with the medium and by the subsequent removal from the medium under elution conditions. The mechanisms involved are currently not clear, but be simplistically be related to the fact that the protein alters conformation to accommodate the interfacial free energy differences between the mobile phase and medium, as well as to enhance reduce its own interfacial free energy via hydrophobic or other interactions with surface groups. The problem of such denaturation is that the protein will retain this new conformation when it is eluted from the medium.

Given the above, there is great interest in the development of chromatography and other separation surfaces which differentiate amongst proteins and other molecules on the basis of their hydrophobicity under conditions which show less tendency to denature proteins.

As an alternative to classic HIC media, involving uncharged hydrophobic ligands, Boschetti et al (Genetic Engineering, vol. 20, No. 13, July, 2000) have suggested a method they denote hydrophobic charge-induction chromatography (CIC) for isolation of sensitive biological macromolecules, especially antibodies. A commercially available product, BioSepra MEP HyperCel (Life Technologies, Inc.), is based on this kind of interaction and comprises 4-mercaptoethylpyridine as ligands. Theoretically, the ligand will be uncharged at neutral pH and binds molecules through mild hydrophobic interaction. As the pH is reduced, the ligand becomes positively charged and the hydrophobic binding is supposedly countered by electrostatic charge repulsion between the ligand charge groups and the protein. However, several problems can be foreseen with this approach. Firstly, it requires target proteins of suitable pI to be net positive at the elution pH. Secondly, the proteins need to have a significant net positive charge at the elution 5 pH. Thirdly, there is a risk that the pyridine group used, by virtue of its close to 7 neutral pKa, promotes other stabilising interactions, such as π-bond overlap, chelation, ion exchange, cation-π, which would compromise it functioning.

As an alternative to the commonly used small ligands, larger molecules, and more specifically polymers, have been suggested for use as the stationary phase in separation applications.

For example, WO 02/30564 (Amersham Pharmacia K.K.) discloses stimulus-responsive polymers for use in affinity chromatography. More specifically, such stimulus-responsive polymers, also known as “intelligent or responsive polymers”, will undergo a structural and reversible change of their physicochemical properties when exposed to the appropriate stimulus. This change can be a conversion of remarkable hydrophobicity, as noted by their self-association in solution, to remarkable hydrophilicity, i.e. hydration, or vice versa. The most common and investigated stimulus is a temperature change, while alternative stimuli suggested in WO 02/30564 are light, magnetic field, electrical field and vibration. While these last four stimuli might be used, with some technical difficulty, in applications involving coated surfaces of small total area, such as microcolumns for analytical chromatography, it is difficult to see how they could successfully be used in applications involving larger columns and surfaces. The careful control of temperature required to promote elution of a target from the separation medium will also require constant conditions surrounding the medium, and consequently a higher demand is put on the equipment used. Use of the suggested alternative stimuli will involve similar drawbacks. Interestingly, it is mentioned in WO 02/30564 that elution by changing the composition of an eluent such as the salt, the inorganic solvent, pH etc. can be undesired, since it can cause problems such as inactivation, reduction in recovery and the like, due to the added chemical substances, such as salts, organic solvents, acids and bases.

Another example of affinity chromatography is disclosed in U.S. Pat. No. 5,998,588 (University of Washington), which relates to interactive molecular conjugates, and more specifically to materials which can be used to modulate or “switch on or off” affinity or recognition interactions between molecules, such as receptor-ligand interactions and enzyme-substrate interactions. Thus, the conjugates disclosed are a combination of stimulus-responsive polymer components and interactive molecules. The polymers can be manipulated by alterations in pH, light or other stimuli. The stimulus-responsive component is coupled to the interactive molecule at a specific site to allow manipulation thereof to alter ligand binding at an adjacent ligand binding site, for example the antigen-binding site of an antibody or the active site of an enzyme.

Another example of polymer coatings as the stationary phase is found in EP 1 081 492 (Amersham Pharmacia Biotech K.K.), wherein chromatographic packings comprised of charged copolymers are disclosed. More specifically, the disclosed packings, which are provided with ion-exchange functions, can be prepared e.g. by copolymerising poly(N-isopropylacrylamide)(PIPAAm) with positively charged dimethylaminopropylacrylamide(DMAPAAm). The resulting packing is usable both in reverse phase chromatography and ion-exchange chromatography. Elution of substances that have been adsorbed to such packings is obtained by changing the hydrophilic/hydrophobic balance on the surface of the stationary phase by changing temperature. However, as mentioned above, temperature control involves certain drawbacks. For example, control of temperature typically requires special equipment, such as heaters, baths, thermometers, column jackets and pumps, for even small columns. When such methodology is applied to larger columns, the equipment becomes more involved as due associated problems including fluid seal leakage between the column jacket and uneven temperature distribution relative to the long axis and diameter of the column will appear. In larger columns, temperature gradients may lead to mixing currents and differences in physical properties, e. g. viscosity, linked to mass transfer and performance over the gel bed.

EP 0 851 768 (University of Washington Seattle) suggests use of stimuli-responsive polymers and interactive molecules to form site-specific conjugates which are useful in assays, affinity separations, processing etc. The polymers can be manipulated through alteration in pH, temperature, light or other stimuli. The interactive molecules can be biomolecules, such as peptides, proteins, antibodies, receptors or enzymes. The stimuli-responsive compounds are coupled to the interactive molecules at a specific site so that the stimulus-responsive component can be manipulated to alter ligand binding at an adjacent binding site. As indicated above, the coupling is by affinity groups, and the materials presented can consequently be “switched on or off” affinity recognition interactions. More specifically, the physical relationship of the polymer to an affinity site of a target compound is controlled by the above-mentioned alterations. Further, ligands or other affinity substances are disclosed, whose basic interactions are modified in a desired fashion by the grafting of responsive polymers to such substances.

Tuncel et al (Ali Tuncel, Ender Unsal, Hüseyin Cicek: pH-Sensitive Uniform Gel Beads for DNA adsorption, Journal of Applied Polymer Science, Vol. 77, 3154-3161, 2000) describe the manufacture of uniform gel beads by suspension polymerisation of an amine-functionalised monomer, N-3-(dimethyl amino)propylmethacrylamide (DMAPM). The disclosed cross-linked gel beads exhibit pH-sensitive, reversible, swelling and de-swelling behaviour, and are suggested for DNA adsorption. However, the field of use of the disclosed beads will be restricted by their rigidity, which is sufficient for some applications, such as drug delivery, while applications wherein higher flow rates are desired will be less satisfactory. For example, the liquid flow through a packed chromatography bed would inevitably collapse such beads, and consequently impair their adsorption properties.

Finally, WO 96/00735 (Massey University) discloses chromatographic resins useful for purifying target proteins or peptides. More specifically, a resin-target complex is disclosed, wherein the resin comprises a support matrix to which selected ionisable ligands have been covalently attached. The ligands render the resin electrostatically uncharged at the pH where the peptide is adsorbed to the resin and electrostatically charged at the pH where the peptide is desorbed. Adsorption to the uncharged resin is obtained by hydrophobic interactions, while desorption is obtained by charge repulsion. The ligands may include amine groups, carboxyl groups, histidyl groups, pyridyl groups, aniline groups, morpholino groups or imidazolyl groups. Further, the ligands may be attached to the support via spacer arms, which are not critical for the invention, and which may e.g. have been derivatised from beta-alanine, aminobutyric acid, aminocaproic acid etc. Since the spacers, if present, do not contain any ionisable groups, they cannot contribute to the desorption properties of the disclosed resin. Thus, the ligands disclosed in WO 96/00735 are all relatively small organic molecules, wherein each ligand commonly presents one functional group. Consequently, the ligands of this resin are quite distinct from the above-discussed stimulus-responsive polymers.

### SUMMARY OF THE INVENTION

A first object of the present invention is to provide a hydrophobic interaction (HIC) separation medium having improved selectivity and/or resolution as compared to conventional HIC media. A specific object is to provide such a medium having such improved selectivity and/or resolution while recovery is at least as good as conventional HIC media.

Another object of the present invention is to provide a method of identifying or isolating at least one target compound from a liquid, wherein the interactions commonly used in hydrophobic interaction chromatography (HIC) are utilised to adsorb a target compound to a medium whose relative hydrophobicity can be varied by mobile phase pH and/or salt concentration. In this case, the hydrophobicity is judged by adsorption of proteins in relation to alkane or phenyl ligand-based surface coatings conventionally used as HIC media.

It is a specific object to provide such a method, wherein pH control is used to alter relative interaction, not just to promote or reduce adsorption on the basis of causing ligands to become charged or uncharged. Thus, using the invention for separation purposes, the operator has another variable, namely pH, that can be used to manipulate the resolution of the method.

Another object of the present invention is to provide a chromatography method, which is more likely to preserve the integrity in terms of native structure and activity of a target compound than prior art methods under adsorption and elution conditions. A specific object is to provide such a method for separation of macromolecules, such as proteins. This can according to the invention be achieved by a method of identifying or isolating at least one target compound from a liquid, wherein hydrophobic interaction is utilised to adsorb a target compound to a medium. More specifically, said medium is comprised of a matrix provided with a flexible polymer surface coating, which changes conformation relative to the target compound during the adsorption and elution processes. Such changes are affected by pH as well as other stimuli previously used in HIC, e. g. salt concentration. Thus, the present method enables the operator more control over operating variables that affect recovery of non-denatured or otherwise altered target material.

A specific object of the invention is to provide a chromatography method, wherein hydrophobic interactions are the primary interactions utilised to adsorb a target compound to a medium whose surface hydrophobicity relative to the target compound can be altered e.g. by pH alteration. In this case, the pH alteration is not dependent on significant alteration of mobile phase salt concentration or use of mobile phase modifiers, such as organic solvent or polymeric additives that modify polarity. The present method may be applied under a wide range of mobile phases as concerns e.g. salt concentrations, organic solvent and polymeric mobile phase modifiers, etc.

A specific object of the invention is to provide a HIC method as discussed above, which expands the possible operating conditions while reducing the operating costs, as compared to the prior art, and to provide a method which has less negative effects on operating equipment than the prior art HIC methods.

An additional object of the invention is to provide a chromatography method, wherein hydrophobic interaction is utilised to adsorb a target compound to a medium, which method allows use of HIC for proteins and polypeptides of reduced limited solubility in the neutral pH range HIC is often employed at. This is achieved by a method, wherein the hydrophobic interaction is related to the conformation of polymers localised at the matrix surface as well as to protein-polymer interaction in relation to pH.

An additional object of the invention is to provide a chromatography method, wherein proteins are eluted in the same order as with classic HIC media, but wherein the relative interaction of selected proteins with the medium, i. e. their peak elution position in relation to other proteins, is modified by alteration of pH. Thus, the present method can improve the resolution available from the HIC method.

Another object of the invention is to provide a chromatography method, wherein a production friendly chromatographic material is used. This can be achieved by use of a matrix that exhibits surface localised polymers, rather than specific hydrophobic ligands, such as commonly used alkane or phenyl groups. The latter often necessitate production costs related to use of hydrophilic coatings to modify native surface hydrophilicity, to tethering groups that ligands are attached to etc, which can be avoided by use of the present method.

A last object of the invention is to reduce the range of media needed to affect desired separations of a variety target compounds, such as proteins. This can be achieved according to the invention by use of a separation medium, whose inherent surface hydrophobicity can be altered by pH control. Since the inherent range of hydrophobicity of classic HIC media is afforded by a range of media with different alkane groups, often at more than one surface density, it is advantageous for both producer and user if the range of media that must be produced and tested in regard to each application is reduced.

Other objects and advantages of the present invention will appear from the detailed description that follows.

### BRIEF DESCRIPTION OF THE DRAWINGS

FIG. 1 shows typical pH 7 salt gradient hydrophobic interaction chromatography (HIC) involving a mixture of four proteins and several commercial media.

FIG. 2 shows chromatograms as in FIG. 1, but demonstrates several other commercial media.

FIG. 3a and b show chromatograms as in FIG. 1 at pH 7 and 4, respectively, but demonstrates the lack of useful effect of pH on commercial media HIC on going from pH 7 to 4.

FIG. 4a and b illustrate typical structures of pH responsive HIC (pHIC) polymer coatings used in the method according to the invention.

FIG. 5 shows typical salt gradient HIC results obtained at pH 4 using methods similar to FIGS. 1 and 2 but various pHIC polymer coatings varying in component molar ratios.

FIG. 6 illustrates how typical pHIC polymer coated media results as pH is altered from pH 7 to 4 showing improved resolution compared to normal HIC media at pH 7 and enhancement of such resolution, and unusual selectivity control as pH is altered.

FIG. 7 shows chromatograms as in FIG. 6, but chromatograms related to individual proteins so as to show the enhanced resolution compared to FIG. 3.

FIG. 8 supports the reproducibility of the results in FIGS. 6 and 7.

### DEFINITIONS

The term “surface-localised” means localisation of a molecule or other substance in proximity to a surface. This can be achieved by any conventional interaction, such as adsorption, covalent bonding etc.

The term “surface” refers to the exterior and, in the case of porous materials, interior or pore surfaces of a matrix.

The term “matrix” is used herein for any one of the conventional kind of solid supports used in the field of identification and isolation, such as in chromatography and filtration.

A “separation medium” is comprised of a matrix as defined above, to which binding groups, such as ligands or polymers, have been attached.

The term “hydrophobicity” is used herein in the meaning generally used within the field of chromatography. There are many common ways of defining the term “hydrophobicity” in this field which are all well known, e.g. in terms of solubility.

The terms “desorption” and “release” are used interchangeably herein.

### DETAILED DESCRIPTION OF THE PRESENT INVENTION

In a first aspect, the present invention relates to a method of isolating at least one target compound from a liquid, which comprises the steps of
(a) contacting the liquid, at a first pH value, with a separation medium that exhibits surface-localised pH-responsive polymers to adsorb the target compound; and
(b) adding an eluent of a second pH value, which provides a conformational change of said pH-responsive polymers, to release said compound(s) from the separation medium.

In one embodiment of the present method, the second pH value is lower than the first pH value. In the most advantageous embodiment, the eluent comprises a decreasing pH gradient. Since the strength of the adsorption depends on the interaction between polymer and target compound, different target compounds can be differentially eluted from the medium by a pH gradient, such as a step-wise or linear pH gradient. Thus, in an advantageous embodiment, step (b) is a differential elution of at least two target compounds. In the present method, each one of the target compounds can be eluted as a pure or substantially pure fraction. Conventionally used additives, such as alcohols, detergents, chaotropic salts etc, can be used in the elution buffer to affect selectivity during desorption in step (b), but care should be taken not to denature or inactivate the target compound by exposure to high concentrations of such additives.

Gradient elution is a well known method in the field of chromatography, and the skilled person can easily decide on a suitable gradient using conventional acid/base systems.

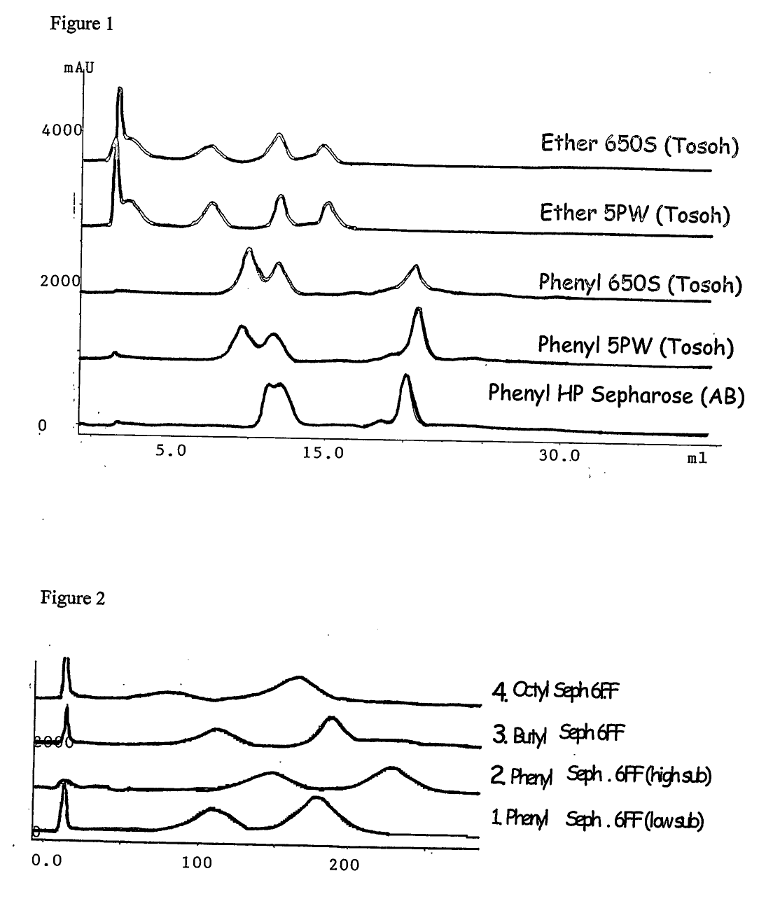

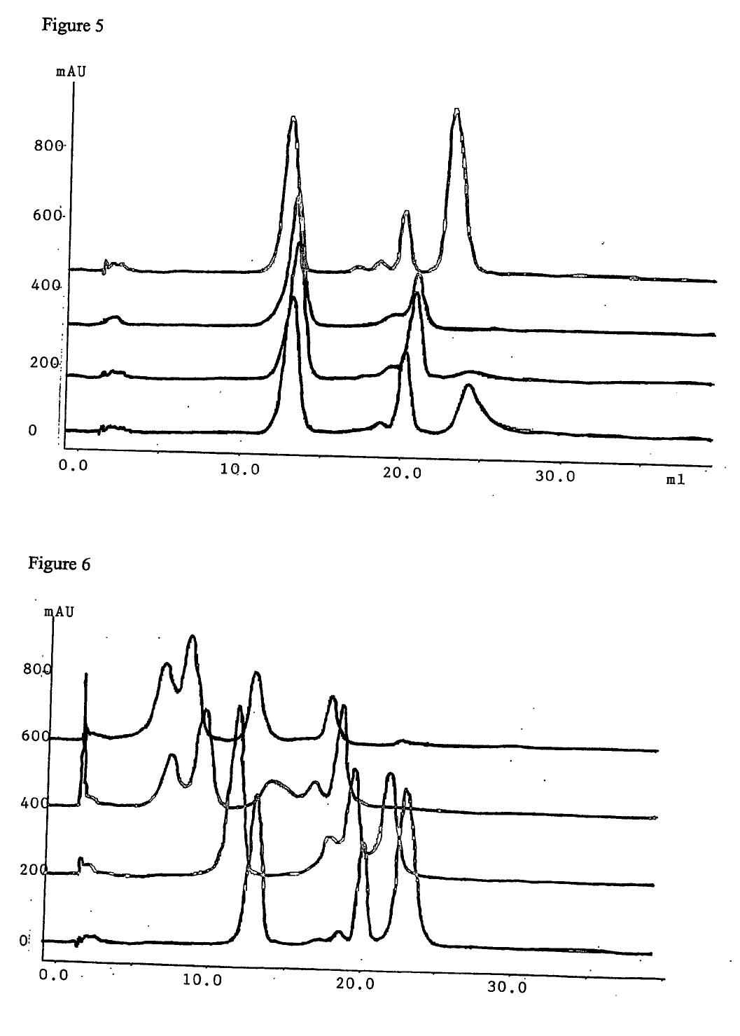

Accordingly, in this embodiment, the physical state of the polymers is changed by a pH alteration. Depending on the nature of the polymer, its tendency to self-associate, and the tendency of the surface to become more adsorptive to a material in relation to its hydrophobicity, may be increased or decreased by the change in pH. In the examples illustrated in FIGS. 5 to 8, it is increased as pH is decreased. As a result, the salt concentration at which a protein is generally eluted from the surface becomes lower, which is the same mechanism as is seen when a classic HIC media surface is made more hydrophobic, as shown in FIGS. 1 and 2.

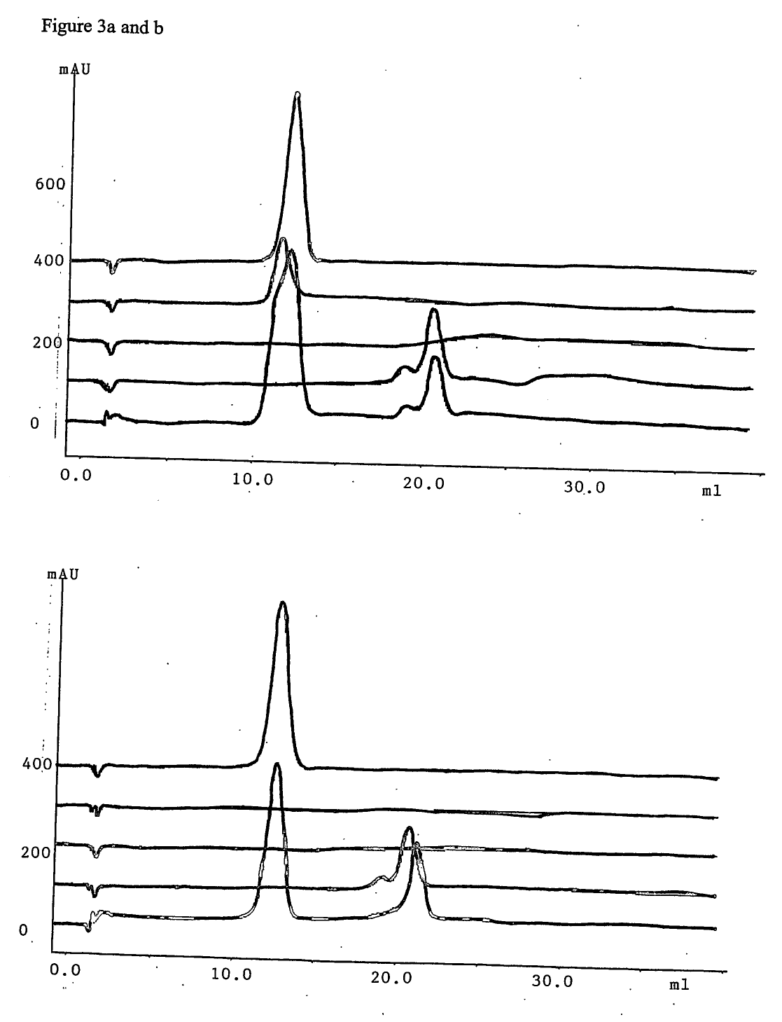

Obviously the opposite should be true, that as pH is altered in favour of less adsorption, there is less strong interaction between the medium and proteins or other adsorbents. In this context, it is understood that the conformational tendencies of the polymers, as they relate to pH, influence pH control over adsorption and desorption. However, as the skilled person will realise, in the present method, the target compound may also undergo a conformational change to a minor extent though, as shown in FIG. 3, not in a manner sufficient to promote its release from the matrix surface. Accordingly, such cases are also embraced within the scope of the invention. Thus, the adsorption and release of the compounds in the present method is promoted primarily and preferably predominantly by a conformational change of the pH-responsive polymers.

The present method can be used to isolate a target compound by adsorption thereof as described above. Thus, in one embodiment of the present method, the adsorbed compound is the target compound. In an alternative embodiment, the invention is used to remove undesired compounds from a liquid by adsorption thereof while the target compound is allowed to pass. In a specific embodiment, the adsorption discussed above is in fact a retardation that enables a satisfactorily isolation and/or identification of a target compound.

In an alternative embodiment of the present method, the conductivity of the eluent differs from the conductivity of the liquid of step (a), while the second pH value is maintained equal or at least essentially equal to the first pH value. In the most advantageous embodiment for isolation of proteins, the elution is performed at neutral or alkaline pH. A change in conductivity is commonly provided by addition of a suitable salt, such as any one of the commonly used for hydrophobic interaction chromatography. In an advantageous embodiment, the eluent comprises a salt gradient. Since the strength of the adsorption depends on the interaction between polymer and target compound, different target compounds can be differentially eluted from the medium by a salt gradient, such as a step-wise or linear salt gradient. In an advantageous embodiment, step (b) is a differential elution of at least two target compounds. In the present method, each one of the target compounds can be eluted as a pure or substantially pure fraction. Conventionally used additives, such as alcohols, detergents, chaotropic salts etc, can be used in the elution buffer to affect selectivity during desorption in step (b), but care should be taken not to denature or inactivate the target compound by exposure to high concentrations of such additives. Gradient elution is a well known method in the field of chromatography, and the skilled person can easily decide on a suitable gradient.

In a specific embodiment, the above discussed pH and salt gradient elutions are combined and both principles utilised for elution of the adsorbed compound(s).

In summary, in step (a) of the present method, depending on the nature of the pH-responsive polymers, the skilled person in this field can easily adapt the conditions for adsorption. For example, as is well known, higher surface tensions provide solvophobically more preferred environments for protein adsorption onto a hydrophobic surface. Thus, use of a salt with a greater molal surface tension will result in an increased retention of such a target compound as protein to the medium. The most commonly used salt in HIC is ammonium sulphate, which however cannot be used in very alkaline environments. Other useful salts are e.g. monosodium glutamate, guanidine, sodium sulphate and sodium aspartate, which are advantageously used at a pH of about 9.5. The present method is most advantageously performed at room temperature.

In one embodiment, the adsorption of the target compound is provided by hydrophobic interaction between the pH-responsive polymers and the target compound. Accordingly, the principle that forms the basis of the present embodiment is sometimes herein denoted “pH responsive HIC (pHIC)”. In a specific embodiment, the adsorption of the target compound is provided by hydrophobic interactions supplemented by related kinds of interactions. Such related interactions are suitably selected from the group that consists of charge-charge interactions, van der Waals interactions and interactions based on cosolvation/cohydration. In an alternative embodiment, which relates to certain cases, such as a specific protein at a certain pH and salt concentration, the related kind of interaction(s) dominate. However, in general, such other interactions are secondary compared to the hydrophobic interactions.

More specifically, in the embodiment that uses salt gradient assisted hydrophobic interactions, target compounds like proteins will in step (a) be adsorbed in relation to the hydrophobicity of the surface, the hydrophobicity of target compound(s) and the nature of the eluent. Accordingly, the interactions are primarily hydrophobic in that they mimic the type of interactions common to classic HIC media, which commonly involves carriers or matrices coated e.g. with alkane or aromatic hydrophobic ligands.

Accordingly, the present invention, which is based on hydrophobic interaction chromatography (HIC) wherein pH-responsive polymers are used, is different from the above discussed charge-induction chromatography (CIC) suggested by Boschetti et al, wherein (1) the ligand involved is a low MW molecule, not a polymer as in the present invention, (2) mobile phase pH is changed so as to cause the ligand to be either neutral when binding or cationic when not binding, (3) it is not suggested by Boschetti et al to provide the ligand change conformation in response to the pH change, (4) the inducible charge group is coupled to a hydrophobic ligand so that it, in effect, represents a modification of classical HIC ligands. Some problems that can be foreseen with the CIC methodology, will be avoided by the present invention, such as problems caused by factors such as (i) protein charge group affinities for the CIC ligand in the charged form, (ii) charge-charge interactions being screened by the higher salt concentrations associated with some HIC buffers as well as (iii) the relationship between ligand density and medium performance.

In one embodiment of the present method, the conformational change of said pH-responsive polymers is the change to a less hydrophobic conformation caused by the pH decreases. In another embodiment, the conformational change of the polymers is based on polymer self-association and/or association with the matrix.

The skilled person in this field can produce suitable pH-responsive polymers, which will pass through a more to less hydrophobic conformation in aqueous or other solution as the pH decreases or increases. This is often accompanied by self-association which is detected when the polymers are free in solution by their coming out of solution. For temperature-responsive polymers in aqueous solution systems there is a lower critical solution temperature (LCST) or an upper upper critical solution temperature (UCST). The LCST of pH-responsive polymers alters with pH, and may also be affected by other factors, e. g. ionic strength and type of ions or other additives in solution. When such polymers are attached to a surface they may still exhibit such conformational alteration that the surfaces relative hydrophobicity varies like that of the polymer. As such the surface-associated polymers may self associate and change conformation in response to pH.

The matrix that exhibits the pH-responsive polymers can be any organic or inorganic porous material that allows coupling of the pH-responsive polymers, as long as it does not exhibit any charges that can interfere with the separation process. Thus, in one embodiment, the matrix is comprised of hydrophilic carbohydrates, such as crosslinked agarose. In this case, which will be described in detail in the experimental part below, the matrix material is first allylated, preferably in the presence of a base such as NaOH, to a suitable extent in accordance with well-known methods, and thereafter it is aminated to allow subsequent coupling of polymers. In an alternative embodiment, the matrix is first allylated and then provided with a coating of pH-responsive polymers by grafting of monomers to the surface. In this embodiment, the monomers are copolymerised directly to the surface. The choice of monomers will enable preparation of polymers of desired responsivity. For example, the skilled person in this field can easily prepare a polymer coating of a desired LCST using standard methods. In a specific embodiment, pH-responsive polymers can be combined with temperature-responsive polymers to provide specific characteristics. In a further embodiment, the matrix as such is prepared by grafting technique.

In an alternative embodiment, the matrix is silica or a synthetic copolymer material. If required, the matrix is allylated as mentioned above, and then aminated. In the context of chromatography, it is most preferred to alkylate any remaining amine groups of the matrix before use, since such groups may otherwise result in a decreased separation of compounds.

The pH-responsive polymers useful in the present method can be any which are sensitive to a pH, wherein a change of surrounding pH will cause significant conformational changes in the polymer coils. For a general review of this kind of polymers, see e.g. Chen, G. H. and A. S. Hoffman, “A new temperature- and pH-responsive copolymer for possible use in protein conjugation”, Macromol. Chem. Phys., 196, 1251-1259 (1995). In specific embodiments, the present pH-responsive polymers are pH-responsive in a range of pH 2-13, such as 2-12, 3-12, 4-7 or 7-10.

In brief, synthetic pH-sensitive polymers useful herein are typically based on pH-sensitive vinyl monomers, such as acrylic acid (AAc), methacrylic acid (MAAc), maleic anhydride (MAnh), maleic acid (MAc), AMPS (2-Acrylamido-2-Methyl-1-Propanesulfonic Acid), N-vinyl formamide (NVA), N-vinyl acetamide (NVA) (the last two may be hydrolysed to polyvinylamine after polymerisation), aminoethyl methacrylate (AEMA), phosphoryl ethyl acrylate (PEA) or methacrylate (PEMA). Such pH-sensitive polymers may also be synthesised as polypeptides from amino acids (e.g., polylysine or polyglutamic acid) or derived from naturally occurring polymers such as proteins (e.g., lysozyme, albumin, casein, etc.), or polysaccharides (e.g., alginic acid, hyaluronic acid, carrageenan, chitosan, carboxymethyl cellulose, etc.) or nucleic acids, such as DNA.

In one embodiment, the pH-responsive polymers are comonomers. In another embodiment, each pH-responsive polymer is comprised of a hydrophobic part, a hydrophilic part and a pH-responsive part. The pH-responsive part preferably comprises amines, such as primary, secondary or tertiary amines, and/or acrylic acid, which protonate at certain pKa values.

In a specific embodiment, said pH -responsive polymers comprise pH-responsive groups selected from the group that consists of —COOH groups; —OPO(OH)₂ groups; —SO₃⁻ groups; —SO₂NH₂ groups; —RNH₂ groups; R₂NH groups; and R₃N groups, wherein R is C.

In a specific embodiment, the present pH-responsive polymers can be engineered to contain one or more functional groups, which provide or enforce the hydrophobic character of the polymer. The most preferred functional groups in the present method are carbon-carbon double bonds (C═C), such as found in unsaturated systems, e.g. in alkenes or aromatic systems.

The pH-responsive surfaces used in the present method can be designed as monolayers or multilayers of functional groups by the skilled person in this field using synthetic organic polymer chemistry. In general, the present pH-responsive polymers useful herein can be synthesised according to standard methods to range in molecular weight from about 1,000 to about 250,000 Daltons, such as from about 2,000 to about 30,000 Dalton. As the skilled person will understand, the lower limit will be determined of factors such as surface covering and how hydrophobic they can be, while the upper limit will be determined by factors such as polymer/diffusion effect.

As indicated above, one illustrative type of pH-responsive polymer can be prepared from an amino acid having one amino group and one carboxyl group and be coupled to a polysaccharide matrix. This monomer is readily polymerised by radical polymerisation to result in a matrix with a constant swelling in the region of pH 4-8 and increased swelling in acidic and basic regions. Another way of coupling the polymers to the matrix surface is by the surface grafting method, wherein a pH-responsive polymer of a definite size is first synthesised and then grafted to the carrier. Yet another known method of producing reversible pH-responsive surfaces is “entrapment functionalisation”, which produces sophisticated, labelled polyethylene oligomers. These oligomers can then be mixed with HDPE that is free of additives. Codissolution of the polymer and the functionalised oligomer produces a homogeneous solution that can be used to produce functionalised PE-film.

In an alternative embodiment, the present method utilises polymers such as Poly(N-acryloyl-N′-propylpiperazine) (PAcrNPP), poly(N-acryloyl-N′-methylpiperazine) (PAcrNMP) and poly(N-acryloyl-N′-ethylpiperazine) (PAcrNEP), are hydrogels that are sensitive to both pH and temperature. N,N-dimethylaminoethyl methacrylate [DMEEMA] based polymers is another group of temperature and pH-responsive hydrogels.

In one embodiment of the present method, at least one target compound is a biomolecule, such as a protein or a peptide. Some specific examples of proteins which are especially suitable in this context are antigens, cellulases, glycoproteins, hormones, immunoglobulins, lipases, membrane proteins, nuclear proteins, placental proteins, ribosomal proteins and serum proteins. The target compound can be present in any liquid, usually an aqueous solution, with the proviso that it is compatible with the adsorption process and that it is not harmful in any way to the pH-responsive polymers or the target compound. In one embodiment, the liquid is a fermentation broth and the target compound is a protein or a peptide that has been produced therein. Such a fermentation broth may, depending on the nature of the pH-responsive polymers, be diluted or undiluted, such as a crude extract.

In the best embodiment at present, the method according to the invention is a chromatographic process. Such chromatography can be preparative, in any scale, up to large production scales, or analytical. Thus, in a specific embodiment, the present method is an analytical process. In an illustrative embodiment, the separation matrix is a microtitre plate, a biosensor, a biochip or the like. In an alternative embodiment, the present invention is utilised in cell culture. The present method is equally useful in small and large-scale equipment.

In an alternative embodiment, the present method is a filtration process. In this case, the matrix can be any well-known material, to which the above-discussed pH-responsive polymers have been coupled according to standard methods. The general principles of filtration are well known to the skilled person.

In a further aspect, the present invention relates to the use of the above-defined pH-responsive polymers in the preparation of a chromatography medium. Accordingly, the invention also encompasses the process of grafting suitable copolymers to a matrix such as agarose, wherein the properties of the copolymers are designed to be pH-responsive under desired circumstances.

Finally, the invention also encompasses the use of pH-responsive polymers to increase or decrease surface adsorption by varying pH. It is a general phenomenon that polymers in solution or on surfaces can interact with proteins or other molecules, such as macromolecules or colloids, in solution or localised at said surfaces. Such interactions can lead to polymer-protein interactions, such as coated surface-protein interactions and are very dependent on the chemical groups of the polymers and the other material. As such they are expected to be related to a range of chemical interactions, e.g. cohydration, hydrophobic, van der Waals and hydrogen bond, and reflect the unique makeup of the other material. The interactions can be used to differentially control interaction of the surface with the material. Note that such interactions may promote and stabilise the self-association tendencies of the polymers.

More specifically, the present use of a separation matrix that exhibits surface-localised pH-responsive polymers separates one or more target compounds from other components of a liquid. In the most advantageous embodiments, said pH -responsive polymers comprise pendant pH-sensitive groups selected from the group that consists of —COOH groups; —OPO(OH)₂ groups; —SO₃⁻ groups; —SO₂NH₂ groups; —RNH₂ groups; R₂NH groups; and R₃N groups, wherein R is C. In a specific embodiment, said polymers have been polymerised in situ onto the matrix surface.

Thus, invention encompasses a process wherein a separation medium that exhibits surface-localised pH-responsive polymers is used to separate biomolecules from other components in a liquid. As discussed above, such a separation may be a chromatographic method or a filtration process. The present use is an advantageous alternative to conventional hydrophobic interaction chromatography (HIC) or reversed phase chromatography (RPC). Further details regarding the pH-responsive polymers can be as discussed above in relation to the method according to the invention.

Finally, the present invention also relates to a hydrophobic interaction chromatography (HIC) medium, which is comprised of a matrix to which surface-localised pH-responsive polymers have been attached, which polymers exhibit HIC ligands. In a specific embodiment, the pH-responsive groups of the polymers have been selected from the group that consists of —COOH groups; —OPO(OH)₂ groups; —SO₃⁻ groups; SO₂NH₂ groups; —CNH₂ groups —C₂NH groups; and —C₃N groups. Further details regarding the present medium and its use may be as described above in relation to the method according to the invention.

In addition, the invention also embraces a kit for isolating target compounds, which kit comprises, in separate compartments, a chromatography column packed with a medium comprised of a matrix to which surface-localised pH-responsive polymers, which exhibit HIC ligands, have been attached; an adsorption buffer of a first pH; an eluent of a second pH, which is lower that said first pH; and written instructions for its use. Said instructions may comprise instructions of how to perform the method according to the invention.

### DETAILED DESCRIPTION OF THE DRAWINGS

FIG. 1 shows chromatograms related to various conventional HIC media, from top to bottom: Ether 650™, Ether 5PW™, Phenyl 650S™ and Phenyl 5PW™ (Tosoh) and Phenyl HP Sepharose™ (Amersham Biosciences, Uppsala, Sweden). The media are denoted by their ligands (phenyl or ether groups). In this example, four proteins (myoglobin, ribonuclease A, α-lactalbumin and α-chymotrypsinogen A) some of whose properties are tabulated in the Experimental section, are added to buffer of 0.1M NaPhosphate pH 7 containing 2M (NH₄)₂SO₄ which is then run as a gradient to 0.1M NaPhosphate and 0M (NH₄)₂SO₄. Runs with single proteins indicate that they elute in the typical “classic” HIC order given above. It appears that (a) the proteins all tend to elute in the same order on the columns—peak resolution varies but not relative peak position, (b) some of the media are better at resolving peaks of the four proteins than others, (c) the media appear to elute different proteins at different salt concentrations, e.g. top to bottom the myoglobin peak appears to elute at 2M (NH₄)₂SO₄ and then at approximately 1M as one goes from ether to phenyl ligand coated media. This suggests, in keeping with the hydrophobicity of phenyl versus ethyl group, stronger protein interactions with the phenyl coated media.

FIG. 2 shows chromatograms related to “classic” gradient HIC performed as in FIG. 1, using the same proteins and conditions, and various Sepharose™ media (all from Amersham Biosciences, Uppsala, Sweden) as follows, from bottom and going up: 1. Phenyl Sepharose™ 6FF (low sub); 2. Phenyl Sepharose™ 6FF (high sub); 3. Butyl Sepharose™ 6FF; and Octyl Sepharose™ 6FF where “sub” denotes relative ligand density which increases with media hydrophobicity. The commercially available media are denoted by their ligands and ligand densities. Individual proteins runs (not shown) indicate that the four proteins eluting in the order noted in FIG. 1 but that (a) the proteins are only resolved into two peaks (myoglobin and ribonuclease followed by α-lactalbumin and α-chymotrypsinogen A), (b) as one goes from media with phenyl groups at low density to higher density the peaks elute at lower salt concentration (indicating stronger interaction with the more hydrophobic media surfaces) and (c) that media hydrophobicity is not just determined by ligand hydrophobicity but by density. Thus, the octyl media with the most hydrophobic ligand but the lowest ligand density (8 umole/ml gel, see Amersham Biosciences Catalogue) is associated with protein peaks which elute before the butyl (50 umole/ml) or phenyl low sub (20 umoles/ml) or high sub (40 umoles/ml) media. Note that the phenyl-HP media in FIG. 1 has a ligand density of 25 umoles/ml gel.

FIG. 3a shows a similar pH 7 gradient HIC study involving the same mixture of four proteins as in FIGS. 1 and 2. The various curves show, from top to bottom: rb, myo, a-lac, a-ch and mixture. Also shown are results for individual protein samples run separately. FIG. 3b shows the same proteins at pH 4. Note that (a) The protein mixture results look similar at both pH's, (b) again only two peaks are resolved, (c) as you go from pH 7 to 4 myoglobin and α-lactalbumin tend to be retained on the column (e. g. exhibit stronger interactions even at lower salt concentrations).

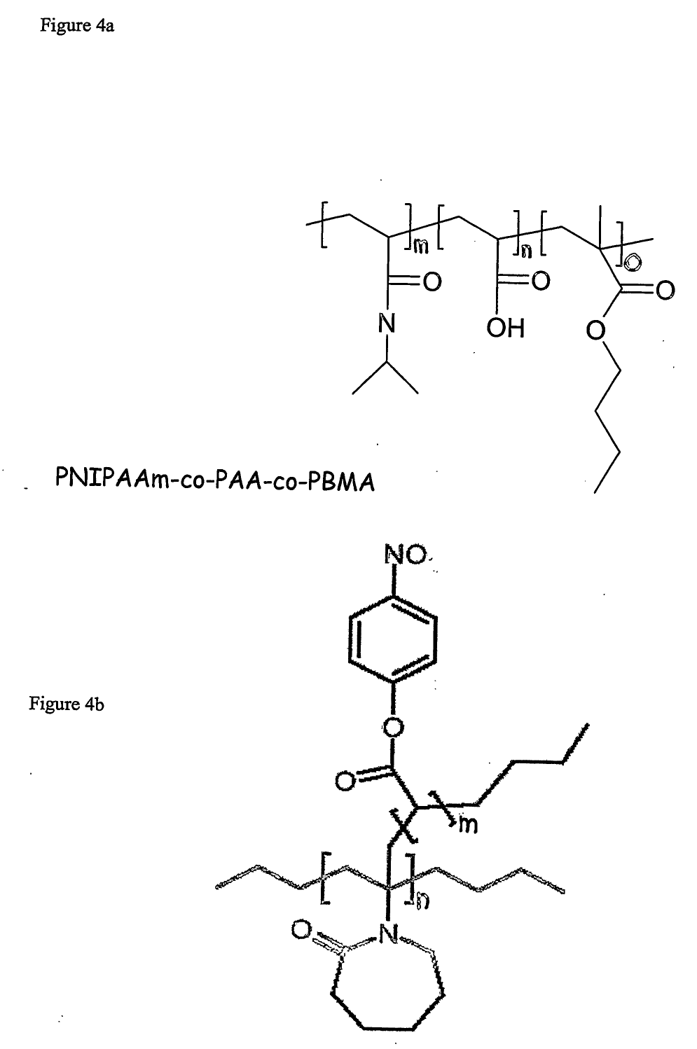

FIG. 4a indicates the general formula for a responsive polymer coating developed to have pH HIC (pHIC) responsiveness over the acidic pH range (e. g. 4 to 7): PNIPAAm-co-PAA-co-PBMA. It is composed of a self associating group “m” with some charge as well as hydrophobic character, a group added to control pH responsiveness “n”—in this case an acid group for acid pH responsiveness, and another group “o” to improve HIC (self association) functionality. As noted in the figure many variables can be modified to optimise the polymer for any particular application, and many other applications are possible other than those demonstrated directly herein. Some more obvious modifications are varying the base matrices, varying the molar ratios of the three functional groups m, n and o, varying the types of groups (e. g., make n a pyridine group and o a phenyl group, utilise four functional groups so as to replace group n with two groups which can buffer each other), alter relative arrangement of the groups. FIG. 4b indicates a different type of pH responsive polymer which was designed for function at basic pH range.

FIG. 5 shows chromatograms related to “classic” gradient HIC with a four protein mixture performed as in above figures, except at pH 4, using media prepared by grafting Sepharose™ media with the polymer in FIG. 4a (UB878029,U878032:1-3). Results with media exhibiting four different molar ratios of the three polymer components are shown. Note (a) molar ratios can be controlled, (b) chromatographic behaviour tends to vary with the molar ratios and can therefore be controlled, (c) polymers with similar molar ratios result in similar HIC chromatograms.

FIG. 6 shows chromatograms related to “classic” gradient HIC with a four protein mixture performed as in above figures, except pH varied from 4 to 7 in both the adsorption and elution steps according to one aspect of the invention, using one of the pH sensitive HIC (pHIC) prototype media coated with polymer as in FIG. 4a (U878032:3). Note that (a) at pH 7 the “pHIC” media exhibits a typical HIC chromatogram with the proteins in normal elution order verified by individual experiments (not shown), (b) resolution of the four peaks is superior or equal to that of the commercial media results shown in FIGS. 1 and 2, (c) as pH is reduced from 4 to 7 the myoglobin (pI 6.3) peak moves from first eluted to last eluted and α-lactalbumin (pI 5) also shifts (see below), (d) while other peaks, e. g. ribonuclease (pI 9.4) and a-chymotrypsinogen A (pI 9.6) hold relative position but tend to be eluted at lower salt concentration. Observation “c” suggests that by altering pH the operator can effect unique separations (e. g. purifying ribonuclease and myoglobin which tend to elute together in classic HIC). Observation “d” suggests that, in analogy to FIGS. 1 and 2, peak movement to the right is associated with increasing media hydrophobicity. As a result the effective salt gradient range of the media may be reduced by reducing pH. So too one media operated at different pH values is able to reproduce chromatographic separations similar to a range of many different media in FIGS. 1 and 2.

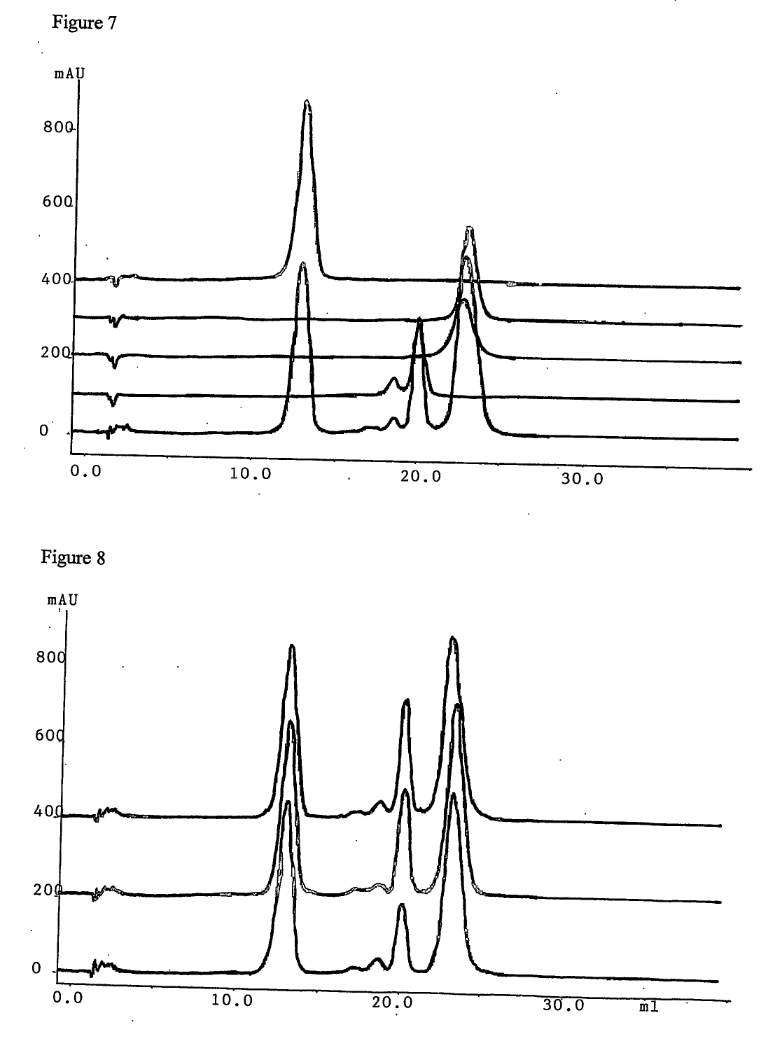

FIG. 7 shows individual protein chromatograms associated with the pH 4 gradient run in FIG. 6 (U878032:3). Compare the peak resolution for the four individual proteins with that for the commercial Phenyl Sepharose™ media in FIG. 3. Note the much improved peak shape, and recovery of myoglobin and α-lactalbumin.

FIG. 8 shows three separate runs with the pHIC media shown in FIG. 6 indicate the reproducibility of the chromatograms. Runs with media of similar molar ratios (not shown) were also similar suggesting reproducibility (robustness) of producing such media.

Experimental Part

The following examples are provided for illustrative purposes only and should not be construed as limiting the scope of the present invention as defined by the appended claims. All references given below and elsewhere in the present specification are hereby included herein by reference.

Materials

| | |
|---|---|
| Separated compounds | |
| Myoglobin | (SIGMA M-1882) |
| Ribonuclease A | (SIGMA R-5000) |
| α-Lactalbumin | (SIGMA-L-5385) |
| α-Chymotrypsinogen A | (SIGMA C-4879) |
| Ammonium Sulphate | (Merck 1.01217.1000) |
| Sodium Sulphate | (Merck 1.06649.1000) |
| O-Phosphoric Acid | (Merck 1.00573.2500) |
| Potassium Hydroxide | (Merck 1.05033.1000) |
| Eluent | |
| Ammonium Sulphate | (Merck 1.01217.1000) |
| O-Phosphoric Acid | (Merck 1.00573.2500) |
| Potassium Hydroxide | (Merck 1.05033.1000) |
| Glycine | (Merck 1.04201.1000) |
| Sodium Hydroxide | (Merck 1.06469.1000) |
| Sodium Sulphate | (Merck 1.06649.1000) |
| Synth. | |
| Sepharose ™ HP | (Amersham Biosciences AB, Sweden) |
| Sodium Hydroxide | (Merck 1.06469.1000) |
| NaBH₄ | (Int. 30011700) |
| Na₂SO₄ | (Merck 1.06649.1000) |
| AGE | (Fatg\dot{a}rden 236093-01) |
| Ethanol | (Kemetyl 201035488) |
| HAc | (Merck 1.00063.1000) |
| NaAc | (Prolabo 27650.292) |
| Br₂ (aq) | (Int.) |
| Sodium Formate | (Merck 1.06443.0500) |
| Diamine hexane | (Fluka 204676) |
| PVCL gr. with p-NPA | (Int. Lund) |
| DMF | (Merck 17134-1) |
| Acetic Anhydride | (M&B A12/64/107-1) |
| Titration | |
| HCl | (Merck 1.00317.1000) |
| HAc | (Merck 1.00063.1000) |
| HNO₃ | |
| AgNO₃ | |
| FTIR | |
| Ethanol | (Kemetyl 201035488) |
| KBr | (Aldrich 22.184-4) |
| NMR | |
| DMSO(d₆) | (CIL 2206-27-1) |
| Acetone (d₆) | (CIL 666-52-4) |
| Methanol (d₄) | (CIL 811-98-3) |
| Chloroform (d) | (CIL 865-49-6) |
| DMF | (ampoule) |
| UV-VIS | |
| Buffer pH7 | (Merck 1.09439.1000) |
| Buffer pH10 | (Merck 1.09438.1000) |
| Buffer pH4 | (Merck 1.09435.1000) |
| GPC | |
| THF | (Merck 1.09731.1000) |
| PS standards | (PL LTD) |

Methods

Instruments

The Hydrophobic Interaction Chromatography was performed on an ÄKTA™ Explorer 10 S (ID 119) (Amersham Biosciences AB, Uppsala, Sweden) equipped with an UV-detector. The columns were of glass and of the type HR 5/5 (18-0383-1).

For the titrations of the gels, an ABU 93 TRIBURETTE (ID 672) (Radiometer Copenhagen) was used. For the titrations of the amine groups a 5-ml Teflon cube (ID 85) was used and for the titrations of the allylic groups a 1-ml Teflon cube (ID 600) was used. A Perkin-Elmer 16 PC (ser.no. 145689) was used for the FTIR analyses of the gels. The gels analysed with NMR were measured with a 50 μl Teflon cube and analysed with an av500. The pure polymers were dissolved and analysed by NMR with an av300.

All measurements of weights were performed on a Metler Toledo (ID 526) for weights≦1 g, and on a Metler PM 480 (ID 635) for weights≧1 g (when no other information is given).

The absorbances of the polymers as a function of the temperature were measured with an Ultraspec 3000 (ID 134). For the GPC in THF a Waters 712 WISP (ID 648), a Water 410 (differential refractometer) and a PL-ELS 1000 (detector) were used.

### EXAMPLE 1

### Preparation of Aminified Allyl Sepharose™ HP

Preparation of Allyl-HP: 100 ml of drained Sepharose™ HP were placed in a 250 ml vessel, 25 ml of water was added and stirring was initiated. After 60 minutes at 50° C., various amounts of NaOH, 0.2 g of NaBH₄ and 6 g of Na₂SO₄ were added and the substances were left to react for 16-20 hours during continuos stirring at 50° C.

Aminification of Allyl-HP: The drained Allyl-HP gel was placed in a vessel with 50-100 ml of water and stirring was initiated. 5 g NaAc was added and Br₂ (aq) was added until a remaining yellow colour was seen, then NaCOOH was added until the colour disappeared, and the gel was washed with water.

A solution of: 17 g 1,6 diamine hexane, 8.8 g NaCl, 50 ml water was prepared and added to the cooling gel. The reaction was allowed to take place in 50° C. for 16-20 hours.

### EXAMPLE 2

### Analyses of the Modified Sepharose™ HP-Gel

Titration Results

The results of the titrations were as expected. The allylic concentration of the gel increased with an increasing weight percentage of sodium hydroxide, as did the chloride ion capacity of the gel (Table 1).

TABLE 1
Titration results for gels with different amounts of added NaOH

| Amount of NaOH | | Cl⁻ capacity of aminified |
|---|---|---|
| added to the gel | Allylic concentration | gel without polymer |
| [g/100 ml gel] | [μmoles/ml] | [μmoles/ml] |
| 4 | 53.8 | 52 |
| 6 | 58.0 | 112 |
| 10 | 73.7 | 121 |

### EXAMPLE 3

### Coupling of PVCL-NPA Copolymers to the Aminified Gels

Preparation of 10 ml of Gel:

10 ml of amine modified agarose particles were washed with DMF. 96 mg of PVCL-NPA were dissolved in 10 ml of DMF and the solution was then added to the agarose particles. The mixture was left to shake over night. 50 μl of acetic anhydride were added to the mixture (to acetylate the residual amino alkyls of the carrier), followed by filtering on a glass filter (pore size 4) and washing with 200 ml of DMF to remove excess polymer.

The evaluation of the gel showed that the acetylation of the amino alkyls had been insufficient, why the volume of added acetic anhydride was increased to 10 ml.

### EXAMPLE 4

### Grafting of PNIPAAm-PAA-co-BMA polymers to the allylated Gels

Monomers and AIBN were measured according to table 2 and dissolved in dioxane in a 15 ml vial. Drained allyl Sepharose™ HP was added to the vial and a rubber septum sealed the container. Ar_{(g)} was bubbled through the vial for five minutes. The vial was then put in a shaking heat-block set to 70° C. and left to react over night.

TABLE 2
Amounts of monomers and AIBN

| | | | | | | | Feed | |
|---|---|---|---|---|---|---|---|---|
| | NIPAAm | AA | BMA | AIBN | HP100 | dioxane | ratio | init |
| sample # | (g) | (ml) | (ml) | (mg) | (g) | (ml) | N:A:B | (mol %) |
| U878029 | 4.04 | 0.307 | 0.714 | 147 | 5 | 8 | 8:1:1 | 2 |
| U878032:1 | 3.54 | 0.307 | 1.427 | 147 | 5 | 8 | 7:1:2 | 2 |
| U878032:2 | 4.55 | 0.307 | 0 | 147 | 5 | 8 | 9:1:0 | 2 |
| U878032:2 | 4.30 | 0.307 | 0.357 | 147 | 5 | 8 | 8.5:1:0.5 | 2 |

The gel was filtered with a glass filter and the eluted solution was recovered in a round flask. Washing of the gel was carried out with dioxane followed by ethanol and water.

The polymer solution was precipitated in diethyl ether and dried in a vacuum oven. The dry polymer was then dissolved in THF and precipitated again. This procedure was continued till a dry and fluffy polymer powder remained.

### EXAMPLE 5

### Analyses

Titration of Amine Groups

The exact amine concentration of the modified agarose was unknown, and had to be determined by titration. The method used (NR 08) involved:
Washing of 15-20 ml of the gel with water, 100 ml of 0.5 M HCl, and finally, 200 ml of 1 mM HCl.
Placing a filter paper on the bottom of the (5 ml) Teflon cube and filling it with gel slurry in 1 mM HCl.
Connecting the cube to water suction until dry gel surface was visible and then for about 30 additional secs.
Removal of the cube and transfer of the gel to the titre cup by addition of water.
Addition of 2-3 drops of concentrated nitric acid and starting of the titration.

Titration of Allyl Groups

The method (NR 08) involved:
The gel was washed with aqua-ethanol-aqua-HAc-aqua.
1 ml of the gel was measured with a Teflon cube (ID 600) as above, transferred to a bottle by addition of distilled water and diluted to a total volume of 10 ml.
Br₂ (aq) was added under stirring until the colour was consistent.
The flask was put under suction until the solution was colourless.
The content of the flask was transferred to the titration vessel with water, diluted to 30 ml, 1-2 drops of concentrated nitric acid was added and titration with AgNO₃ was initiated.

Titration of Carboxylic Group

1 ml of gel was measured in a Teflon cube. The gel was transferred to a titration beaker with 15 ml of 1 M KCl. pH was lowered bellow three before titration was started. Titration was carried out with 0.1 M NaOH till pH 11.5

Analyses of the Gels by NMR (HR-MAS)

The polymer-coated gels were analysed with HR-MAS (magic angle spin) this method enables analysis of the attached polymer with minimum disturbance from the gel matrix.

50 μl of gel was measured in a Teflon cube and washed with 1 ml water followed by 2*500 μl DMSO. 10 μl of TMB was placed in the bottom of the probe before the gel was added. TMB serves as an internal standard it makes comparison of peak integrals for quantitative calculations possible.

Analyses of the Pure Polymers and Monomer by NMR

When ¹H-NMR was run at monomers or pure polymer (polymer not attached to gel) 10 mg of sample was dissolved in 0.70 ml deuterated solvent.

UV-VIS

The lower critical solution temperature, LCST, was analysed with an UV-spectrophotometer. A 1% solution of polymer in buffer was prepared. The buffer solutions used were 0.1 M potassium phosphate with pH ranging from 4 to 7 (the same buffers are used in HIC). The solution was placed in a 1 cm sample cell. Water was used as a reference. The clouding point was observed with the optical transmittance of 500 nm. The temperature interval measured was 20-75° C. with a heating rate of 0.5° C./min. The LCST was defined as the temperature at the inflection point in the absorbance versus temperature curve.

GPC

The polymers were dissolved in THF (0.5mg polymer/ml THF) and the solutions were filtered before they were added to the vials. Two different standards, each containing PS with three different molecular weights were also prepared, filtered and added to vials. The vials were then put in an automated, rotating vial holder from which the apparatus took the samples and injected them into the analysing system

### EXAMPLE 6

### Chromatographic Evaluation

Packing of the Columns

The columns were carefully packed with slurries of polymer coupled Sepharose™ HP (Amersham Biosciences, Uppsala, Sweden) and ethanol (20% b.v.) with a Pasteur pipette until there was only a few mm of space left at the top of the column. A few drops of ethanol were added and the columns were sealed and attached to the HIC apparatus.

The Separation Material

The protein mixture consisted of four proteins; myoglobin 1.0 mg/ml, ribonuclease A 2.0 mg/ml, α-lactalbumin 0.8 mg/ml, and α-chymotrypsinogen A 0.8 mg/ml. The proteins were dissolved in 2.0 M ammonium sulphate/0.1 M potassium phosphate buffer pH 7. The protein solution samples were stored in a freezer. Proteins were also chromatographic separately with myoglobin 1.0 mg/ml, ribonuclease A 2.0 mg/ml, α-lactalbumin 0.8 mg/ml and α-chymotrypsinogen A 0.8. The proteins were dissolved in 2.0 M ammonium sulphate/0.1 M potassium phosphate buffer with pH 7. The protein solution samples were stored in a freezer.

Two different buffer systems were used depending on pH range (see table 3). The A-buffer has a “salting-out” effect and promotes protein-HIC media interaction, where as the lower ionic strength of the B-buffer promotes elution.

TABLE 3
Buffers used in HIC Studies

| | A-buffer | B-buffer |
|---|---|---|
| pH 4-7 | 2.0 M ammonium sulphate/ | 0.1 M potassium phosphate |
| | 0.1 M potassium phosphate | |
| pH 8-10 | 1.0 M sodium sulphate/ | 0.1 M glycine/NaOH |
| | 0.1 M glycine/NaOH | |

HIC was run with a salt gradient from 100% A-buffer to 100% B-buffer the flow rate was 1 ml/min. The UV detector operated at 215, 254 and 280 nm. The injection volume was 50 μl. The pH and temperature was held constant during each run.

Properties of the Test Proteins

Some properties of the proteins used in the test mixture (Table 4). Note that on going from pH 7 to 4 two of the proteins (myoglobin and ribonuclease) pass through their isoelectric pH and change net charge from negative to positive while the other two proteins retain their net positive charge. Source Protein Data Bank (www.rcsb.org/pdb/).

TABLE 4
Description of four different proteins

| | | | | | Surface | Surface | Surface | Net |
|---|---|---|---|---|---|---|---|---|
| | PDB | | | | Cationic | Anionic | Hydrophobic | Charge |
| Protein and Source | code | pl | MW | Residues | Residues | Residues | Residues | pH 7 |
| α-chymotrypsinogen A (bovine) | 1gcd | 9.4 | 24861 | 237 | 17 | 9 | 14 | 6.8 |
| α-lactalbumin (bovine) | 1f6r | 5.0 | 14168 | 123 | 13 | 16 | 4 | −4.3 |
| Ribonuclease A (bovine) | 1afk | 9.6 | 13672 | 124 | 12 | 6 | 12 | 5.8 |
| Myoglobin (equian) | 1azi | 6.3 | 16933 | 153 | 18 | 22 | 17 | −2.5 |

### EXAMPLE 7

### Results of Polymer Analyses

NMR Results

The values estimated with NMR analyses (Table 5) should not be regarded as exact values. The peaks were not clearly separated which lead to a certain unreliability of the results. The results were estimated by comparing groups of peaks instead of single peaks, which is the preferred way. The poorly separated peaks are probably due to the fact that it was difficult to find a good solvent for the polymers that enabled them to rotate freely.

TABLE 5
Comparison between supplier's m:n
values and those estimated by NMR

| Number of PVCL | m:n value according to | m:n value estimated |
|---|---|---|
| grafted with p-NPA | supplier | by NMR analyses |
| 1 | 7:93 | 6:94 |
| 2 | 16:84 | 15:83 |
| 3 | 12:88 | 14:86 |
| 4 | 8:92 | 6:94 |

UV-VIS Results

According to theory the LCST value is supposed to increase when a hydrophilic component is added and decrease when the comonomer is hydrophobic. In this case acrylic acid is more hydrophilic and butyl methacrylate (BMA) is less hydrophilic than N-isopropyl acrylamide.

The LCST was defined for this study as represented by the temperature at the inflection point in the absorbance versus temperature curve.

At low pH the LCST values ate under 32° C. but this also holds for polymer where no BMA has been added. This polymer in fact has the lowest LCST value of them all. The water solubility of the polymers are not too good, it is difficult to get a 1% solution.

On the other hand the polymers' cloud points are very pH dependent. At pH 4 and 5 LCST values are around 25-30° C. but when pH is increased above 5, LCSTs are observed at about 70° C. At pH 7 no LCSTs are seen in the observed temperature range (20-75° C.). The carboxylic group in AA is charged at pH 6 and 7 increasing the hydrophilicity and therefore the LCST.

It can be concluded that changing the pH from 7 to 4 at ambient temperature should lead to a conformational change in the polymer structure for all studied PNIPAAm-co-PAA-co-PBMA compositions. The hydrophilicity of the polymers is much greater at pH above five and no clouding of the polymer solutions are observed at pH 7.

GPC Results

Chromatograms from GPC of the tripolymers of NIPAAM, AA and BMA show broad peaks and sometimes multiple peaks. This could mean that there are homo-polymers and co-polymers in the sample.

TABLE 6
Polydispersity

| | | | Polydis- |
|---|---|---|---|
| sample name | Description | Mₙ | persity |
| U878019 | PNIPAAm-co-PAA 9:1 (TA) | 2343 | 1.32 |
| U878021 | PNIPAAm-co-PAA 9:1 (TA) | 2146 | 1.6 |
| U878029 | PNIPAAm-co-PAA-coPBMA 8:1:1 | * | — |
| U878032:1 | PNIPAAm-co-PAA-coPBMA 7:1:2 | 15484 | 3.6 |
| U878032:2 | PNIPAAm-co-PAA-coPBMA 9:1 | 26550 | 3.8 |
| U878032:3 | PNIPAAm-co-PAA-coPBMA 8.5:1:0.5 | * | — |

*Multiple peaks with no resolution

The polydispersity for polymers synthesised without transfer agent are high and molecular weights differ considerably between the different systems although the reaction conditions are the same except for the feed ratio of monomers (table 6).

### EXAMPLE 8

### HIC Evaluation

Control HIC using Phenyl Sepharose™ HP media

A control study was made with Phenyl-Sepharose™ HP (Phe-HP) media. Column preparation and the chromatographic method used was the same as for all of the columns.

FIG. 3a and b show the results obtained with Phe-HP media at both pH 7 and 4 for both our standard protein mixture and for individual proteins. One can clearly see that there is very little difference in the protein mixture chromatograms run at pH 7and at pH 4. Such lack of pH responsiveness is actually seen as a positive attribute for classical HIC media. However in both cases there is no resolution of more than two large peaks. One can also see from the individual protein runs that at pH 7 the first peak is composed of myoglobin and ribonuclease A while the second peak is composed of -chymotrypsinogen A (a bimodal peak) and -lactalbumin (a very broad low “peak”).

Changing the pH to 4 still leaves two large protein mixture peaks. Individual runs indicated these are still influenced respectively by ribonuclease A, -chymotrypsinogen A.

The myoglobin and -lactalbumin do not appear to be eluted or may possibly be eluted in very broad, low “peaks”.

Control HIC using PNIPPAm-co-PAA-co-PBMA

Four gels with different feed ratios of NIPAAm, AA and BMA where packed to columns and HIC was run with protein mixture at pH 4 to 7 (Table 7).

TABLE 7
Columns used in HIC evaluation

| Column name | feed ratio N:A:B |
|---|---|
| U878029 | 8:1:1 |
| U878032:1 | 7:1:2 |
| U878032:2 | 9:1:0 |
| U878032:3 | 8.5:1:0.5 |

All four gels show promising HIC media behaviour (FIG. 3a and b) compared to the commercial Phenyl-HP media (FIG. 5). At pH 4, U878032:3 has an large peak at 22 min elution time this peak can also be seen (although smaller) in columns U878029 and U878032:1 while the chromatogram with U878032:2 lacks this peak completely. The best results were obtained with two media (032:3 and 029) of similar composition (Table 7).

That similarly good results can be obtained with slightly different formulations suggests reproducibility of the results. It also suggests that slight variations in production runs of such media would still result in good media. However it should be noted that results appear to depend on adequate ratios of AA to BMA and this should be further investigated.

Column U878032:3 was selected for further evaluation with protein mixtures (FIG. 6) with positions verified using separate proteins. Separate protein chromatograms are shown below (FIG. 7 and 8) with mean peak positions given in Table 8 expressed in terms of the relative elution salt concentration (ammonium sulphate).

In all chromatograms from HIC run on U878032:3 at pH 4-7 α-chymotrypsinogen A shows double peak behaviour with a small peak followed by a larger one. As noted in the introduction this is quite typical. All proteins are eluted at lower salt concentrations when pH is decreased (Table 8 and FIG. 6). This suggests some possibility that the pH-responsive polymer media might allow for HIC under lower salt conditions.

TABLE 8
Column U878032:3 run at different pH

| | Peak centre expressed as | | | |
|---|---|---|---|---|
| U878032:3 | ammonium sulphate salt concentration [M] | | | |
| Protein | pH 4 | pH 5 | pH 6 | pH 7 |
| Myoglobin | 0 | 0 | 1.46 | 1.51 |
| Ribonuclease A | 0.88 | 0.98 | 1.23 | 1.35 |
| α-lactalbumin | 0 | 0.24 | 0.79 | 0.90 |
| α-chymotrypsinogen A:1 | 0.30 | 0.37 | 0.51 | 0.53 |
| α-chymotrypsinogen A:2 | 0.12 | 0.21 | 0.30 | 0.39 |

Note:
Above represent mean peak positions; chymotrypsinogen eluting, as is normal, in two peaks

At pH 7 proteins are eluted in the expected order myoglobin, ribonuclease A, α-lactalbumin and finally α-chymotrypsinogen A. Resolution between myoglobin and ribonuclease A is not satisfactory but protein peak resolution is as good as many commercial media.

When pH is changed to 6 elution times are somewhat longer but the relative order of elution is the same as for pH 7. There is perhaps more resolution of the myoglobin and ribonuclease A peaks but the α-lactalbumin (pI 5) peak is not as sharp as at pH 7.

The order of elution has altered at pH 5. Myoglobin (pI 6.3) which elutes first at pH 7 and 6 now has changed net charge to approximately +8 and becomes the last protein to be eluted. The α-chymotrypsinogen A and α-lactalbumin are eluted at almost the same salt concentration right before myoglobin. So the relative positions of ribonuclease, α-lactalbumin and α-chymotrypsinogen A are still in keeping with their normal HIC behaviour (i. e. relative hydrophobicities).

At pH 4 myoglobin and α-lactalbumin (the two proteins with acidic pI's) are eluted at the same concentration (100% B-buffer) resulting in one single peak in the protein mixture. The order of elution is now ribonuclease A, α-chymotrypsinogen (the two proteins with basic pI's) then α-lactalbumin and myoglobin (FIG. 7).

1. A method of isolating at least one target compound from a liquid, which method comprises the steps of
(a) contacting the liquid, at a first pH, with a separation medium that includes surface-localised pH-responsive polymers to adsorb the target compound(s) via hydrophobic interactions; and
(b) adding an eluent of a second pH value, which eluent provides a conformational change of said pH-responsive polymers, to release the target compound(s) from the separation medium.

2. The method of claim 1, wherein the second pH value is lower than the first pH value.

3. The method of claim 2, wherein the eluent comprises a decreasing pH gradient.

4. The method of claim 1, wherein the conductivity of the eluent differs from the conductivity of the liquid of step (a), while the second pH value is essentially equal to the first pH value.

5. The method of claim 1, wherein the eluent comprises a salt gradient.

6. The method of claim 1, wherein in step (a), the separation medium is uncharged.

7. The method of claim 1, wherein in step (a), the target compound(s) are adsorbed also by additional interactions between pH-responsive polymers and target compounds, said additional interactions being selected from the group consisting of charge-charge interactions, van der Waals interactions and interactions based on cosolvation/cohydration.

8. The method of claim 1, wherein in step (b), the separation medium is uncharged.

9. The method of claim 1, wherein in step (b), the pH-responsive polymers are less hydrophobic than in step (a).

10. The method of claim 1, wherein the conformational change of the polymers is provided by polymer self-association and/or polymer association with the medium.

11. The method of claim 1, wherein the pH-responsive polymers are copolymers.

12. The method of claim 1, wherein each pH-responsive polymer includes a hydrophobic part, a hydrophilic part and a pH-responsive part.

13. The method of claim 1, wherein the pH-responsive polymers include pendant pH-sensitive groups selected from the group consisting of —COOH groups; —OPO(OH)₂ groups; —SO₃⁻ groups; SO₂NH₂ groups; —CNH₂ groups —C₂NH groups; and —C₃N groups.

14. The method of claim 1, wherein the target compound is a biomolecule.

15-18. (canceled)

19. A hydrophobic interaction chromatography (HIC) medium, which is comprised of a matrix to which surface-localised pH-responsive polymers have been attached, which polymers include HIC ligands.

20. The medium of claim 19, wherein the pH-responsive groups of the polymers have been selected from the group consisting of —COOH groups; —OPO(OH)₂ groups; —SO₃^{—} groups; SO₂NH₂ groups; —CNH₂ groups —C₂NH groups; and —C₃N groups.

21. A kit for isolating target compounds, which kit comprises, in separate compartments, a chromatography column packed with a medium comprised of a matrix to which surface-localised pH-responsive polymers, which exhibit HIC ligands, have been attached; an adsorption buffer of a first pH; and an eluent of a second pH, which is lower that said first pH.

22. The kit of claim 21, wherein the pH-responsive groups of the polymers have been selected from the group consisting of —COOH groups; —OPO(OH)₂ groups; —SO₃^{—} groups; SO₂NH₂ groups; —CNH₂ groups —C₂NH groups; and —C₃N groups.
